(19) United States
(12) Patent Application Publication
(10) Pub. No.: US 2019/0227218 A1
(43) Pub. Date: Jul. 25, 2019

(54) LIGHTING DEVICE AND DISPLAY DEVICE

(71) Applicant: Sharp Kabushiki Kaisha, Sakai City (JP)

(72) Inventor: Akira KAWANO, Sakai City (JP)

(21) Appl. No.: 16/249,933

(22) Filed: Jan. 17, 2019

(30) Foreign Application Priority Data
Jan. 24, 2018 (JP) 2018-009677

(51) Int. Cl. F21V 8/00

(52) U.S. Cl. CPC G02B 6/0051; G02B 6/0091

(57) ABSTRACT

A lighting device includes a light source configured to emit light and a light guide plate of a plate shape having an edge surface that is opposite the light source and toward which light is emitted by the light source. The light guide plate includes a through-hole penetrating therethrough in a plate-thickness direction and a region around the through-hole, and the region includes a highly refractive region positioned at least on an opposite side from the light source and having a refractive index higher than a refractive index of another region.

### CROSS REFERENCE TO RELATED APPLICATION

This application claims priority from Japanese Patent Application No. 2018-009677 filed on Jan. 24, 2018. The entire contents of the priority application are incorporated herein by reference.

### TECHNICAL FIELD

The technology described herein relates to a lighting device and a display device that include a through-hole.

### BACKGROUND

In recent years, in electronic apparatus such as information terminals, and in devices such as instruments provided in vehicles including passenger vehicles, liquid crystal panels have been widely used as display panels for displaying images and information. This type of display devices includes, in addition to a liquid crystal panel, a backlight device (lighting device) for supplying light to the liquid crystal panel.

For example, a backlight device of edge-light type (or side-light type) is known which is provided with a light guide plate made of a transparent plate-shaped member, and a light source (such as LEDs) opposing an end surface of the light guide plate. Light emitted from the light source of the backlight device enters the light guide plate via the end surface (hereinafter “light incident surface”) of the light guide plate opposing the light source. The light propagates in the light guide plate, and exits via a front-side plate surface (hereinafter “light exit surface”) as planar light. The edge-lit type backlight device, compared to other types (such as direct-type), has the advantage that the device can be made thinner. An example of such backlight device is disclosed in Japanese Unexamined Patent Application Publication No. 2013-149559.

However, in the edge-light type backlight device disclosed in Japanese Unexamined Patent Application Publication No. 2013-149559, in a configuration in which the plate surfaces are provided with a hole, the light that has entered the light guide plate via the light incident surface and that travels straight toward an incident opposite surface positioned on the opposite side of the light incident surface has its path blocked by the hole. As a result, luminance is decreased in a region positioned on the incident opposite surface side with respect to the hole, causing luminance unevenness.

The problem of luminance unevenness may be solved by adopting a configuration in which a light source is additionally provided on the incident opposite surface side. The configuration, however, would make the configuration of the light source arrangement complex, and would lead to an increase in the size and cost of the backlight device.

### SUMMARY

The technology described herein was made in view of the above circumstances. An object is to provide a lighting device and a display device with which it is possible to suppress luminance unevenness using a simple configuration, even when the device is provided with a hole.

According to the technology described herein, a lighting device includes a light source configured to emit light and a light guide plate of a plate shape having an edge surface that is opposite the light source and toward which light is emitted by the light source. The light guide plate includes a through-hole penetrating therethrough in a plate-thickness direction and a region around the through-hole, and the region includes a highly refractive region positioned at least on an opposite side from the light source and having a refractive index higher than a refractive index of another region.

In this configuration, of the light emitted from the light source, the light that has entered the highly refractive region is refracted by a highly refractive material of which the highly refractive region is formed. The direction of refraction is such that, according to the Snell's law, the angle of refracted light is smaller than the angle of incident light with respect to the normal to the boundary with the highly refractive region. That is, the refracted light of the light that has entered laterally is refracted in a direction toward the through-hole. Accordingly, compared to a configuration without the highly refractive region, the incident light can reach the opposite side (back side) of the through-hole as viewed from the light source.

Thus, the region that the light emitted from the light source would conventionally not reach by being blocked by the through-hole in the light guide plate without the highly refractive region can be efficiency illuminated as the light that has entered the highly refractive region is refracted in a specific direction. Accordingly, a lighting device can be obtained in which luminance unevenness is suppressed as a whole.

According to the technology described herein, a lighting device and a display device can be obtained in which, even when a hole is provided therein, luminance unevenness can be suppressed using a simple configuration.

### BRIEF DESCRIPTION OF THE DRAWINGS

FIG. 1 is an exploded perspective view of a liquid crystal display device according to one embodiment.

FIG. 2 is a longitudinal cross sectional view of the liquid crystal display device.

FIG. 3 is a partially enlarged longitudinal cross sectional view of the liquid crystal display device.

FIG. 4 is a plan view of a light guide plate.

FIG. 5 is a partially enlarged plan view of the light guide plate.

### DETAILED DESCRIPTION

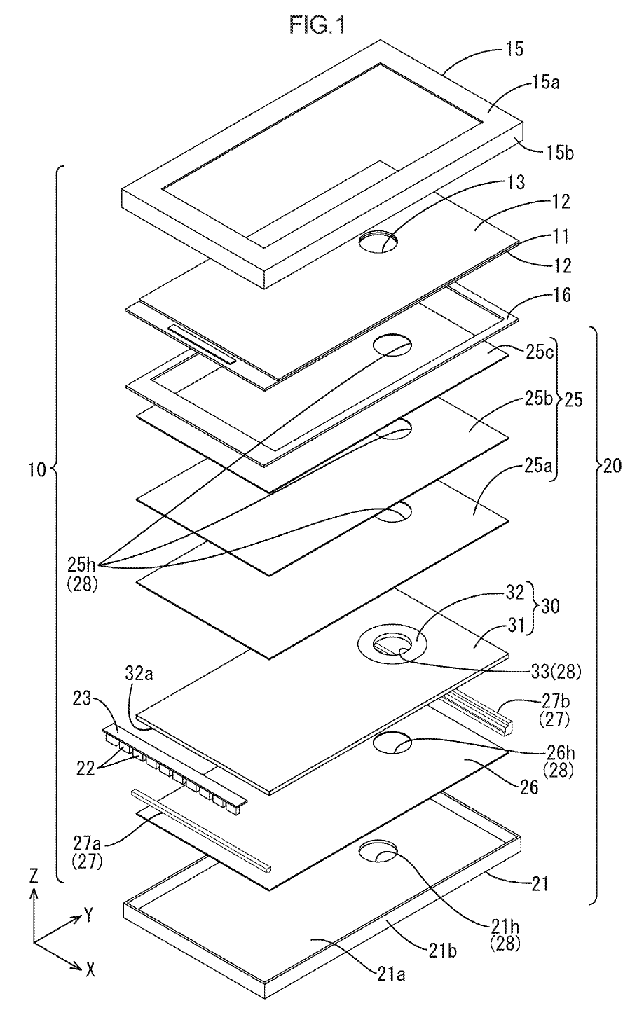

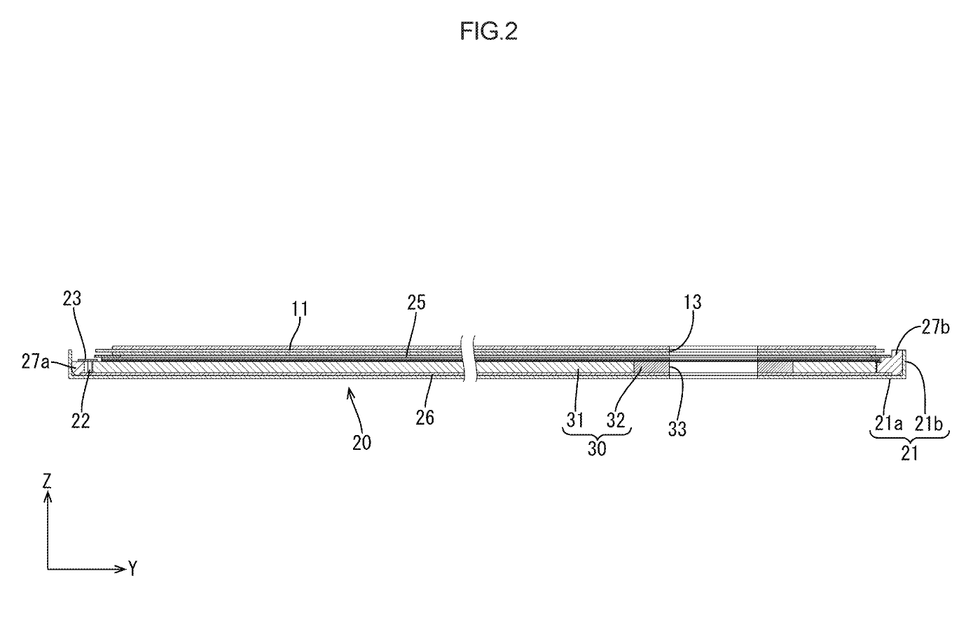

An embodiment will be described with reference to FIGS. 1 to 5. In the present embodiment, a liquid crystal display device (an example of a display device) 10 which is provided with a liquid crystal panel 11 as a display panel will be described by way of example. In some of the drawings, the X-axis, the Y-axis, and/or the Z-axis may be indicated, and the respective axial directions correspond to the directions indicated in the drawings. Upper/lower directions may be indicated with reference to FIG. 2, in which the upper side corresponds to the front side and the lower side corresponds to the back side. The X-axis direction corresponds to a width direction or a lateral side.

As illustrated in FIG. 1, the liquid crystal display device 10 has a generally rectangular shape, and is provided with a liquid crystal panel (an example of a display panel) 11 configured to display an image, and a backlight device (an example of a lighting device) 20 which is disposed on the back side with respect to the liquid crystal panel 11, and which supplies the liquid crystal panel 11 with light for presenting a display. The liquid crystal panel 11 and the backlight device 20 are integrally held by means of a frame-like bezel 15 and the like. The liquid crystal display device 10 according to the present embodiment is used by being assembled onto the dashboard of a passenger vehicle, for example. The liquid crystal display device 10 may constitute a part of an instrument panel and may be configured to display a part of an instrument in the instrument panel, various warning images, a map image for a car navigation system, or an image captured by an on-board camera.

The liquid crystal panel 11 has a rectangular plate shape, and includes a pair of transparent (highly light-transmissive) glass substrates affixed to each other with a predetermined gap therebetween. A liquid crystal layer is disposed between the glass substrates (of which detailed illustration is omitted). One of the glass substrates is provided with switching elements (such as TFTs) connected to source wires and gate wires which are disposed orthogonal to each other; pixel electrodes connected to the switching elements; and an alignment film and the like. The other glass substrate is provided with a color filter having a predetermined arrangement of colored portions of red (R), green (G), and blue (B), for example; counter electrodes; and an alignment film and the like. The source wires, gate wires, counter electrodes and the like are configured to be supplied with image data or various control signals from a drive circuit substrate which are required for displaying an image. A polarizing plate 12 is disposed on the outside of each of the glass substrates.

The liquid crystal panel 11 is configured to display an image using light supplied from the backlight device 20. The front side of the liquid crystal panel 11 corresponds to the light output side. The liquid crystal panel 11 has a long-side direction aligned with the Y-axis direction; a short-side direction aligned with the X-axis direction; and a thickness direction aligned with the Z-axis direction.

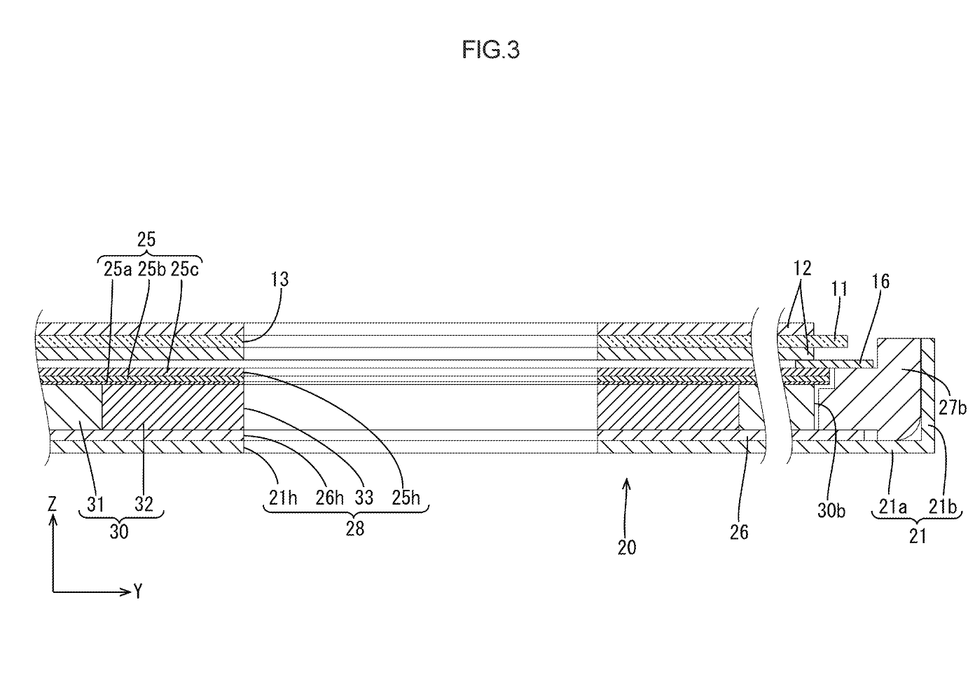

The liquid crystal panel 11 of the present embodiment has a panel-side through-hole 13 formed penetrating therethrough. The panel-side through-hole 13 communicates with a device-side through-hole 28, which will be described later, of the backlight device 20 (see FIG. 3). The panel-side through-hole 13 is provided to pass an object, such as the needle of a mechanical instrument, provided in the instrument panel, which may be disposed on the back side of the liquid crystal display device 10. A hole edge portion of the panel-side through-hole 13 is sealed with a seal member to prevent leakage of the liquid crystal.

The bezel 15 is made of a metal material (such as aluminum) and, as illustrated in FIG. 1, has a generally rectangular frame shape. The bezel 15 includes a panel pressing portion 15a which presses peripheral end portions of the liquid crystal panel 11 along the entire circumference thereof from the front side, and outer enclosure portions 15b which protrude from peripheral edge portions of the panel pressing portion 15a toward the back side, and which enclose the backlight device 20 from the peripheral sides thereof. The liquid crystal panel 11 is sandwiched and held between the bezel 15 and the backlight device 20, and is fixed to the backlight device 20 by means of a frame-shaped panel fixing tape 16.

The panel fixing tape 16 is made of synthetic resin. The panel fixing tape 16 includes a base material having a generally rectangular frame shape extending along the peripheral end portions of the liquid crystal panel 11, with an adhesive material applied to both surfaces of the base material. The base material of the panel fixing tape 16 has a light-shielding black surface to prevent the transmission of leakage light from the backlight device 20 through non-display regions of the liquid crystal panel 11.

The backlight device 20 has a generally rectangular, substantially block-like shape in plan view, similarly to the liquid crystal panel 11. As illustrated in FIG. 1 to FIG. 3, the backlight device 20 is provided with a substantially box-like chassis 21 having an opening on the liquid crystal panel 11 side; an LED substrate 23 having light emitting diodes (LEDs) 22 mounted thereon as a light source; a light guide plate 30 which guides the light emitted from the LEDs 22; optical sheets 25 laminated and arranged on the front side of the light guide plate 30; a reflective sheet 26 laminated and arranged on the back side of the light guide plate 30; and a pair of holders 27 disposed along the short sides of the chassis 21.

The backlight device 20 is of a one-side light-entry type, i.e., the edge-lit type (side-light type) in which the LEDs 22 (LED substrate 23) are disposed on the end surface along one short side of the light guide plate 30, where the light enters the light guide plate 30 only from one side thereof. The backlight device 20 is configured to convert the light from the LEDs 22 into planar light and to cause the light to exit toward the liquid crystal panel 11 on the front side via the opening portion of the chassis 21. That is, the front side of the backlight device 20 corresponds to the light output side. Hereinafter, the constituent components of the backlight device 20 will be described in order.

The chassis 21 is made of a metal material, such as an aluminum plate or an electrogalvanized steel plate (SECC). As illustrated in FIG. 1, the chassis 21 is rectangular in a plan view, similarly to the liquid crystal panel 11. The chassis 21 has a substantially box-like shape with an opening on the front side, and accommodates the LED substrate 23, the light guide plate 30 and the like therein. The chassis 21 includes a rectangular bottom plate portion 21a, and side plate portions 21b respectively rising from the edge portions of the bottom plate portion 21a (a pair of long sides and a pair of short sides) toward the front side. The bottom plate portion 21a of the chassis 21 has a long-side direction aligned with the Y-axis direction and a short-side direction aligned with the X-axis direction. The bottom plate portion 21a of the chassis 21 includes, at a position corresponding to the panel-side through-hole 13 of the liquid crystal panel 11, a through-hole 21h communicating with the panel-side through-hole 13.

The bottom plate portion 21a is configured to support the members accommodated in the chassis 21 from the back side. The side plate portions 21b are disposed so as to enclose the members accommodated in the chassis 21 from the peripheral side. Thus, the side plate portions 21b form a generally longitudinal rectangular frame shape. The side plate portions 21b are configured to be enclosed by the outer enclosure portions 15b of the bezel 15 from the peripheral side. The side plate portions 21b and the outer enclosure portions 15b are respectively provided with holding structures that hold the chassis 21 and the bezel 15 in an assembled state.

The pair of holders 27 are made of white synthetic resin. As illustrated in FIG. 1, the pair of holders 27 each have a thin and long angular-bar shape extending in the short-side direction (the X-axis direction; the width direction) of the chassis 21, and are mounted to the chassis 21 in a state of being disposed along the side plate portions 21b along the short sides of the chassis 21. Of the pair of holders 27, one (holder 27a) which is disposed on the side of a light incident surface 30a (left side in FIG. 2) of the light guide plate 30, as will be described later, includes an upper surface on which the LED substrate 23 is placed, as will be described later. Of the pair of holders 27, the one (holder 27b) disposed on the side of an incident opposite surface 30b (right side in FIG. 2 and FIG. 3) of the light guide plate 30, as will be described later, includes an upper surface forming a stepped surface configured to place the panel fixing tape 16. The holders 27 each include, on the lower surface side thereof, a stepped surface for pressing down on the reflective sheet 26, as will be described later.

As illustrated in FIG. 1, the LEDs 22 include LED chips (LED elements), which are semiconductor light-emitting elements, and a resin material with which the LED chips are sealed on substrate portions fixedly attached to a plate surface of the LED substrate 23, as will be described later. The LED chips mounted on the substrate portions have a single main emission wavelength. Specifically, the LED chips emit the single color of blue. On the other hand, the resin material with which the LED chips are sealed contains a phosphor dispersed and blended therein that emits a predetermined color by being excited by the blue light emitted from the LED chips. Thus, the LEDs 22 as a whole emit generally white light. The LEDs 22 are of the so-called side surface light-emitting type in which the side surface adjacent to a mounting surface with respect to the LED substrate 23 forms a light-emitting surface 22a.

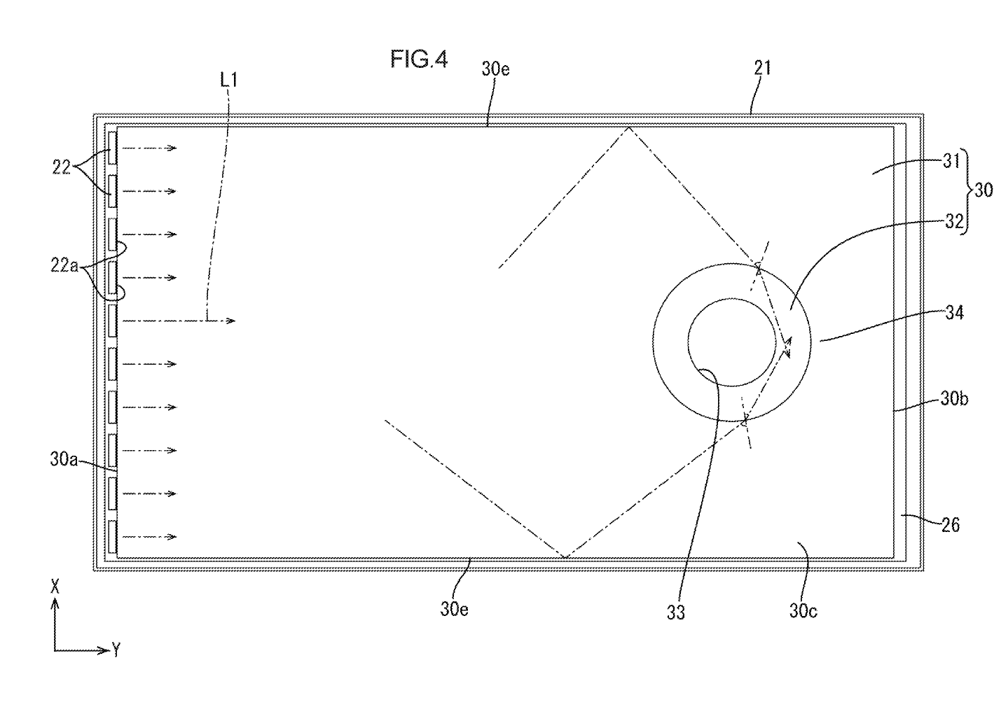

In the LEDs 22, light having a predetermined expansion (directivity) about an optical axis L1 exits from the light-emitting surface 22a. In the present embodiment, the optical axis L1 of the exit light is substantially vertical with respect to the central portion of the light-emitting surface 22a (see FIG. 4). Accordingly, of the light from the LEDs 22 that travels toward the end surfaces (an incident opposite surface 30b and a pair of side surfaces 30e which will be described later) other than the light incident surface 30a of the light guide plate 30, a greater amount of light travels toward the incident opposite surface 30b than toward the pair of side surfaces 30e.

The LED substrate 23 includes a flexible, film-like (sheet-shaped) base material made of an insulating material. The LEDs 22 are surface-mounted on the LED substrate 23 in an intermittently arranged manner (see FIG. 1). The LED substrate 23 is patterned with a wiring pattern for supplying power to the LEDs 22. The LED substrate 23 has a long side dimension which is equivalent to the short side dimension (width dimension) of the light guide plate 30, as will be described later, and a short side dimension which is set greater than an interval between the holder 27a and the light guide plate 30 (see FIG. 2).

The mounting surface of the LED substrate 23 for the LEDs 22 faces the back side (the opposite side from the liquid crystal panel 11 side). The LED substrate 23 is disposed on the front side of the light guide plate 30 with one of a pair of long sides of the LED substrate 23 extending along one of the pair of short sides (the short side on the light incident surface 30a side) of the light guide plate 30, and with the other side disposed on the front side of the holder 27a. Thus, the LEDs 22 are arranged with the light-emitting surface 22a opposing and in parallel with one short-side end surface (light incident surface 30a) of the light guide plate 30, as will be described later.

The light guide plate 30 will be described. In the present embodiment, the light guide plate 30 as a whole is made of a transparent synthetic resin and the like, such as acrylic resin or polycarbonate. As illustrated in FIG. 1 and FIG. 2, the light guide plate 30 has a rectangular plate shape slightly smaller than the bottom plate portion 21a of the chassis 21 in a plan view, and is disposed in parallel with the bottom plate portion 21a of the chassis 21. The light guide plate 30 has a long-side direction (length direction) aligned with the Y-axis direction, and a short-side direction (width direction) aligned with the X-axis direction. A plate-thickness direction of the light guide plate 30 orthogonal to the plate surface thereof is aligned with the Z-axis direction. The light guide plate 30 is accommodated in the chassis 21 with the periphery of the light guide plate 30 being enclosed by the side plate portions 21b.

Of the peripheral end surfaces of the light guide plate 30, the short-side end surface to the left in FIG. 2 and FIG. 4 is the light incident surface 30a which is disposed in parallel with and opposing the light-emitting surface 22a of the LEDs 22, and via which the light from the LEDs 22 enters, as described above. In the present embodiment, the end surface (the end surface to the right in FIG. 2 to FIG. 4) positioned on the opposite side from the light incident surface 30a is the incident opposite surface 30b. Of a pair of plate surfaces of the light guide plate 30, the upper surface (front surface) is a light exit surface 30c for exiting light toward the liquid crystal panel 11. Of the pair of plate surfaces, the lower surface (back surface) is a reflecting surface 30d which reflects light travelling from within the light guide plate 30 toward the lower surface (back surface) back toward the light exit surface 30c. Of the peripheral end surfaces of the light guide plate 30, the long-side end surfaces (the end surfaces other than the light incident surface 30a and the incident opposite surface 30b) are a pair of side surfaces 30e.

The light guide plate 30 is disposed directly under the liquid crystal panel 11 with the optical sheets 25 therebetween. In a state in which the liquid crystal panel 11 and the light guide plate 30 are assembled in a regular position, a light guide plate-side through-hole 33 is provided in a position corresponding to the panel-side through-hole 13.

In the light guide plate 30 according to the present embodiment, a region around the entire circumference of the light guide plate-side through-hole 33 including a hole edge portion thereof is formed of a highly refractive material having a higher refractive index than that of a region (an example of another region) other than the surrounding region. Specifically, the surrounding region is formed from a material having a refractive index higher than that of acrylic resin, polycarbonate and the like. For example, the surrounding region is made from a general-purpose optical plastic resin, such as polymethylmethacrylate resin or highly refractive glass. Hereinafter, the region (around the through-hole 33) formed of the highly refractive material will be referred to as a highly refractive portion 32, and the region other than the highly refractive portion 32 will be referred to as a body portion 31.

The highly refractive portion 32 may be integrally formed with the body portion 31 by two-color molding or insert-molding a ring formed from the highly refractive material, for example. Alternatively, the highly refractive portion 32 may be provided by assembling a separately formed ring onto the body portion 31. When assembled, it is preferable to use an adhesive agent of the same type as the constituent material of the body portion 31 or the highly refractive portion 32, so that no air layer is formed between the ring (highly refractive portion 32) and the body portion 31.

In the present embodiment, the highly refractive portion 32, as illustrated in FIG. 4, is formed with the same width along the entire circumference of the circular (cylindrical) light guide plate-side through-hole 33. The width may be set, as appropriate, in accordance with the size of the light guide plate 30, the position or size of the light guide plate-side through-hole 33, the refractive index of the highly refractive portion 32, or the specifications of the LEDs 22, for example.

In the present embodiment, as illustrated in FIG. 2 and FIG. 4, the panel-side through-hole 13 and the light guide plate-side through-hole 33 are respectively provided in a position in the liquid crystal panel 11 and the backlight device 20 which is disposed eccentrically toward the opposite side (the incident opposite surface 30b side) of the LEDs 22 in the long-side direction (the Y-axis direction).

On the light exit surface 30c of the light guide plate 30, three layers of the optical sheets 25 are laminated. As illustrated in FIG. 1, the optical sheets 25 have a flat rectangular sheet-shaped with a long-side direction aligned with the Y-axis direction and a short-side direction aligned with the X-axis direction.

The optical sheets 25, interposed between the light guide plate 30 and the liquid crystal panel 11, transmits the exit light from the light guide plate 30 and causes the transmitted light to exit toward the liquid crystal panel 11 while providing the transmitted light with a predetermined optical action.

According to the present embodiment, the optical sheets 25 include, in order from the bottom layer side, a diffuser 25a, a lens sheet 25b, and a reflective polarizing sheet 25c, which are stacked together. The diffuser 25a includes a substantially transparent base material of synthetic resin in which a number of diffusing particles are dispersed and blended to diffuse light. The diffuser 25a is stacked directly over the light guide plate 30, and is disposed the closest among the optical sheets 25 to the light guide plate 30. The reflective polarizing sheet 25c includes peripheral end portions to which the back-side surface of the panel fixing tape 16 is fixedly attached.

On the other hand, on the back surface side (reflecting surface 30d side) of the light guide plate 30, the reflective sheet 26 is laminated. The reflective sheet 26 is made of a synthetic resin sheet material having a highly light-reflective white surface. Accordingly, the reflective sheet 26 is configured to efficiently cause light that has propagated within the light guide plate 30 and exited via the reflecting surface 30d to rise toward the front side (light exit surface 30c). The reflective sheet 26 has a rectangular shape in plan view, and is disposed with a large part thereof on the central side being sandwiched between the light guide plate 30 and the bottom plate portion 21a of the chassis 21. The peripheral end portions of the reflective sheet 26 extend outside the peripheral end surfaces of the light guide plate 30, the end portions along a pair of short sides being pressed by the holders 27. The end portion of the reflective sheet 26 on the LED substrate 23 side is configured to efficiently reflect the light directly coming from the LEDs 22 and to cause the light to enter the light incident surface 30a.

The optical sheets 25, the reflective sheet 26, and the bottom plate portion 21a of the chassis 21 respectively have through-holes 25h, 26h, and 21h penetrating therethrough at the position corresponding to the light guide plate-side through-hole 33 of the light guide plate 30, forming a device-side through-hole 28 as a whole.

The operation and effects of the liquid crystal display device 10 according to the present embodiment configured as described above will be described.

In the edge-lit type backlight device 20, as described above, the light guide plate-side through-hole 33 is formed penetrating through the plate surfaces of the light guide plate 30. In this configuration, some of the light that has entered the light guide plate 30 with a directivity via the light incident surface 30a has its path blocked by the object passed through the light guide plate-side through-hole 33, or by the light guide plate-side through-hole 33 itself. As a result, a blocked region 34 that the light does not reach develops on the incident opposite surface 30b side of the light guide plate-side through-hole 33.

With respect to the problem, according to the present embodiment, the backlight device 20 includes the light guide plate 30 including a plate-shaped member, and the LEDs 22 opposing the end surface (light incident surface 30a) of the light guide plate 30 and emitting light toward the end surface. The light guide plate 30 includes the light guide plate-side through-hole 33 penetrating therethrough in the plate-thickness direction. The highly refractive portion 32 having a higher refractive index than that of the body portion 31 is provided along the entire circumference of the light guide plate-side through-hole 33.

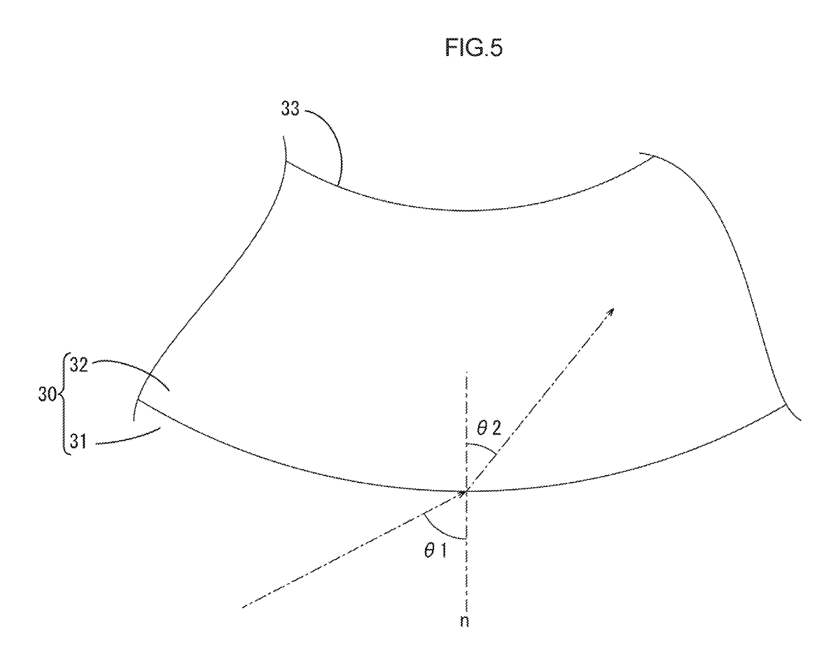

In this configuration, of the light emitted from the LEDs 22, the light that has entered the highly refractive portion 32 is refracted by the highly refractive material of the highly refractive portion 32. As illustrated in FIG. 5, the direction of refraction is such that, according to the Snell's law, the angle (θ2) of refracted light becomes smaller than the angle (θ1) of incident light with respect to a normal n to the boundary with the highly refractive portion 32 (when the refractive index n1 of the body portion 31 is smaller than the refractive index n2 of the highly refractive portion 32). In other words, the refracted light is refracted in a direction toward the light guide plate-side through-hole 33. Accordingly, compared to a conventional configuration in which the highly refractive portion 32 is not provided, the incident light can reach the opposite side (back side; to the right of FIG. 4) of the light guide plate-side through-hole 33 as viewed from the LEDs 22.

Thus, the blocked region 34 that the light emitted from the LEDs 22 would conventionally fail to reach due to the blocking by the light guide plate-side through-hole 33 in a light guide plate without the highly refractive portion 32 can be efficiency illuminated as the light that has entered the highly refractive portion 32 is refracted in a specific direction. Accordingly, the backlight device 20 can be provided in which luminance unevenness is suppressed as a whole.

The highly refractive portion 32 is provided along the entire circumference of the light guide plate-side through-hole 33. In this configuration, compared to a configuration in which the highly refractive portion 32 is provided only partially around the light guide plate-side through-hole 33, it is easy to achieve position alignment and an overall balance during production. Accordingly, it is possible to produce the light guide plate 30 having the highly refractive portion 32 relatively easily.

The light guide plate 30 has a rectangular plate shape, and the LEDs 22 are opposed to one short-side end surface (light incident surface 30a) of the pair of short sides of the light guide plate 30. The light guide plate-side through-hole 33 is disposed eccentrically toward the opposite side (the right side in FIG. 2 and FIG. 4) of the LEDs 22 in the long-side direction (the Y-axis direction) of the light guide plate 30.

In this configuration, the blocked region 34 that the light does not reach tends to be formed in the region on the opposite side (back side) of the light guide plate-side through-hole 33 as viewed from the LEDs 22. Accordingly, by providing the highly refractive portion 32, a significant effect can be obtained.

Of the pair of plate surfaces of the light guide plate 30, one plate surface is the light exit surface 30c from which light exits, and the diffuser 25a for diffusing light may be laminated on the light exit surface 30c side. In this configuration, luminance variation in the light guide plate 30 can be made less visible.

According to the liquid crystal display device 10 and the backlight device 20 of the present embodiment, even when the through-holes 13, 33 are provided, luminance unevenness can be suppressed using a simple configuration.

### Other Embodiments

The technology described herein is not limited to the embodiment described above with reference to the drawings. The following embodiments may be included in the technical scope.

(1) The highly refractive portion 32 may be provided only in the region which, around the light guide plate-side through-hole 33, is positioned on the opposite side (incident opposite surface 30b side) of the light guide plate-side through-hole 33 as viewed from the LEDs 22.

(2) The form of the light guide plate is not limited to that of the foregoing embodiment, and may have other forms, such as a circular light guide plate.

(3) The light guide plate-side through-hole 33 may be provided in any position.

(4) The optical sheets 25 are not limited to the three-layer structure of, in order from the bottom layer, the diffuser 25a, the lens sheet 25b, and the reflective polarizing sheet 25c which are stacked together. For example, the configuration of the optical sheets 25 may include other types of optical sheets that are stacked. The configuration of the optical sheets 25 may include a single layer structure, a double-layer structure, or a structure of four or more layers.

(5) The structure for holding the liquid crystal panel 11 and the light guide plate 30 together is not limited to as described in the foregoing embodiment, and may be modified, as appropriate.

1. A lighting device comprising:
a light source configured to emit light; and
a light guide plate of a plate shape having an edge surface that is opposite the light source and toward which light is emitted by the light source, the light guide plate including a through-hole penetrating therethrough in a plate-thickness direction and a region around the through-hole, the region including a highly refractive region positioned at least on an opposite side from the light source and having a refractive index higher than a refractive index of another region.

2. The lighting device according to claim 1, wherein the highly refractive region extends around an entire circumference of the through-hole.

3. The lighting device according to claim 1, wherein:
the light guide plate has a rectangular plate shape including a pair of short sides,
the light source is opposite the edge surface along one of the pair of short sides of the light guide plate, and
the through-hole is disposed closer to the opposite side from the light source with respect to a long-side direction of the light guide plate.

4. The lighting device according to claim 1, wherein
the light guide plate includes a pair of plate surfaces and one of the plate surfaces is a light exit surface through which the light exits, and the lighting device further comprising
a diffuser disposed on a light exit surface side of the light guide plate and configured to diffuse light.

5. A display device comprising:
the lighting device according to claim 1; and
a display panel configured to present a display using light from the lighting device.

6. The display device according to claim 5, wherein the display panel includes a panel-side through-hole communicating with the through-hole of the light guide plate and penetrating through the display panel in a thickness direction.
